(19) United States
(12) Patent Application Publication
(10) Pub. No.: US 2025/0328515 A1
(43) Pub. Date: Oct. 23, 2025

(54) METADATA UPDATING

(71) Applicant: QUALCOMM Incorporated, San Diego, CA (US)

(72) Inventors: Liang LI, San Diego, CA (US); Andrew Evan GRUBER, Arlington, MA (US); Jonnala Gadda NAGENDRA KUMAR, San Diego, CA (US); Thomas Edwin FRISINGER, Shrewsbury, MA (US); Zilin YING, San Diego, CA (US); Srihari Babu ALLA, San Diego, CA (US)

(21) Appl. No.: 19/255,979

(22) Filed: Jun. 30, 2025

Related U.S. Application Data
(63) Continuation of application No. 18/177,390, filed on Mar. 2, 2023.

(51) Int. Cl. G06F 16/23; G06F 16/22

(52) U.S. Cl. CPC G06F 16/23; G06F 16/2282

(57) ABSTRACT

Aspects of the disclosure are directed to metadata updating. In accordance with one aspect, an apparatus includes an external memory unit configured for storing an original descriptor tag; a descriptor loading block coupled to the external memory, the descriptor loading block configured to fetch the original descriptor tag from the external memory for storage in an internal cache memory and further configured to compare the original descriptor tag stored in the internal cache memory to each of a plurality of original base values; and a remap table database coupled to the descriptor loading block, the remap table database configured to store the plurality of original base values, a plurality of updated base values and a plurality of updated miscellaneous base values.

### CLAIM OF PRIORITY

This application is a continuation application of patent application Ser. No. 18/177,390 filed Mar. 2, 2023, the entire contents of the prior application are incorporated herein by reference as if fully set forth below in its entirety and for all applicable purposes.

### TECHNICAL FIELD

This disclosure relates generally to the field of information processing, and, in particular, to metadata updating.

### BACKGROUND

A modern trend in information processing systems is the utilization of multiple processing engines or processing cores with higher performance for increasingly demanding user applications. Many current information processing systems include a central processing unit (CPU), a graphics processing unit (GPU), a digital signal processor (DSP), an image signal processor (ISP), a neural processing unit (NPU), etc. along with a hierarchy of memory units and associated interconnection databuses. In some applications, particularly in computer graphics, various metadata, such as descriptors, may need to be updated during execution. It is often desired to make changes to the allocation or location of a surface referenced in a descriptor after the descriptor has already been written to memory or made part of a command stream. Such late patching can be difficult as it requires finding and updating all places where the descriptor references the given surface. A mechanism to eliminate the need for such late patching and the requirement for changing descriptors that are already written to memory is described. For such metadata updating, improved performance of an information processing system may be attained by a more efficient memory access scheme.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides metadata updating. Accordingly, an apparatus including a non-transitory external memory unit configured for storing an original descriptor tag, wherein the original descriptor tag includes information of an object which is rendered and a value related to a graphical surface location; a remap table database coupled to the non-transitory external memory unit, the remap table database to store a plurality of original base values, a plurality of updated base values, and a plurality of updated miscellaneous base values, wherein each of the plurality of original base values represents a starting surface location in the non-transitory external memory unit; and a descriptor loading block coupled to the non-transitory external memory, the descriptor loading block to fetch the original descriptor tag from the non-transitory external memory for storage in an internal cache memory and to compare an original base value of the original descriptor tag stored in the internal cache memory to each of the plurality of original base values in the remap table database, and to replace the original base value of the original descriptor tag with an updated base value of the plurality of updated base values in the remap table database, wherein the original base value is not equal to the updated base value.

In one example, the descriptor loading block is further configured to replace an original base value of the original descriptor tag with an updated base value of the plurality of updated base values. In one example, the descriptor loading block is further configured to replace an original miscellaneous base value of the original descriptor tag with an updated miscellaneous base value of the plurality of updated miscellaneous base values. In one example, the descriptor loading block is configured to store an updated descriptor tag in the internal cache memory unit within the descriptor loading block. In one example, the updated descriptor tag includes the updated base value and the updated miscellaneous base value.

In one example, the apparatus further includes a first auxiliary processing engine configured to utilize the updated descriptor tag. In one example, the apparatus further includes a second auxiliary processing engine configured to utilize the updated descriptor tag.

In one example, the descriptor loading block is further configured to copy the original descriptor tag and to relabel it as an updated descriptor tag. In one example, the original descriptor tag as compared to each of the plurality of original base values yields no match. In one example, the remap table database is part of the descriptor loading block. In one example, the internal cache memory is dedicated to the descriptor loading block.

Another aspect of the disclosure provides a method for updating metadata, the method including fetching an original descriptor tag from a non-transitory external memory, wherein the non-transitory external memory stores a plurality of original base values, a plurality of updated base values, a plurality of miscellaneous base values, and a plurality of updated miscellaneous base values, and wherein each of the plurality of original base values represents a starting surface location in the non-transitory external memory unit; storing the original descriptor tag in an internal cache memory of a processing engine, and wherein the original descriptor tag includes information of an object which is rendered and a value related to a graphical surface location; comparing the original descriptor tag to a plurality of descriptor update tags, wherein the original descriptor tag and the plurality of descriptor update tags are stored in the internal cache memory; and replacing an original base value of the original descriptor tag with an updated base value of the plurality of updated base values, wherein the original base value is not equal to the updated base value.

In one example, the method further includes generating an updated descriptor tag if the original descriptor tag matches one or more of the plurality of descriptor update tags. In one example, the method further includes replacing an original base value of the original descriptor tag with an updated base value of a plurality of updated base values.

In one example, the method further includes replacing an original miscellaneous base value of the original descriptor tag with an updated miscellaneous base value of a plurality of updated miscellaneous base values. In one example, the plurality of updated base values and the plurality of updated miscellaneous base values are stored in a remap table database within the processing engine.

In one example, the method further includes copying the original descriptor tag as a reproduced descriptor tag if the original descriptor tag does not match any of the plurality of descriptor update tags. In one example, the method further includes relabeling the reproduced descriptor tag as an updated descriptor tag and storing the updated descriptor tag in the internal cache memory of the processing engine.

In one example, the plurality of descriptor update tags is stored in a remap table database within the processing engine. In one example, the internal cache memory is dedicated to the processing engine.

Another aspect of the disclosure provides an apparatus for updating metadata, the apparatus including means for storing a plurality of original base values, a plurality of updated base values, a plurality of miscellaneous base values, and a plurality of updated miscellaneous base values, and wherein each of the plurality of original base values represents a starting surface location in the non-transitory external memory unit; means for fetching an original descriptor tag from the non-transitory external memory; means for storing the original descriptor tag within a processing engine; means for comparing the original descriptor tag to a plurality of descriptor update tags, wherein the original descriptor tag and the plurality of descriptor update tags are stored in an internal cache memory; and means for replacing an original base value of the original descriptor tag with an updated base value of the plurality of updated base values, wherein the original base value is not equal to the updated base value, and wherein the original descriptor tag includes information of an object which is rendered and a value related to a graphical surface location.

In one example, the apparatus further includes means for generating an updated descriptor tag if the original descriptor tag matches one or more of the plurality of descriptor update tags. In one example, the apparatus further includes means for replacing an original base value of the original descriptor tag with an updated base value of a plurality of updated base values. In one example, the apparatus further includes means for replacing an original miscellaneous base value of the original descriptor tag with an updated miscellaneous base value of a plurality of updated miscellaneous base values.

In one example, the apparatus further includes means for copying the original descriptor tag as a reproduced descriptor tag if the original descriptor tag does not match any of the plurality of descriptor update tags. In one example, the apparatus further includes means for relabeling the reproduced descriptor tag as an updated descriptor tag and means for storing the updated descriptor tag in the internal cache memory.

Another aspect of the disclosure provides a non-transitory computer-readable medium storing computer executable code, operable on a device including at least one processor and at least one memory coupled to the at least one processor, wherein the at least one processor is configured to implement updating metadata, the computer executable code including: instructions for causing a computer to fetch an original descriptor tag from an external memory; instructions for causing the computer to store the original descriptor tag in an internal cache memory of a processing engine; instructions for causing the computer to store a plurality of descriptor update tags in the internal cache memory of the processing engine; and instructions for causing the computer to compare the original descriptor tag to the plurality of descriptor update tags.

In one example, the non-transitory computer-readable medium further includes instructions for causing the computer to generate an updated descriptor tag if the original descriptor tag matches one or more of the plurality of descriptor update tags. In one example, the non-transitory computer-readable medium further includes: instructions for causing the computer to replace an original base value of the original descriptor tag with an updated base value of a plurality of updated base values; and instructions for causing the computer to replace an original miscellaneous base value of the original descriptor tag with an updated miscellaneous base value of a plurality of updated miscellaneous base values.

In one example, the non-transitory computer-readable medium further includes instructions for causing the computer to copy the original descriptor tag as a reproduced descriptor tag if the original descriptor tag does not match any of the plurality of descriptor update tags; and instructions for causing the computer to relabel the reproduced descriptor tag as an updated descriptor tag and to store the updated descriptor tag in the internal cache memory.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example information processing system with multiple slices.

FIG. 3 illustrates an example information processing system for metadata updating.

FIG. 4 illustrates an example flow diagram for updating metadata in an information processing system.

FIG. 5 illustrates an example flow diagram for updating a descriptor in an information processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An information processing system, for example, a computing system with multiple slices (e.g., processing engines) or a system on a chip (SoC), requires multiple levels of coordination or synchronization. In one example, a slice includes a processing engine (i.e., a subset of the computing system) as well as associated memory units and other peripheral units. In one example, execution of an application (e.g., a graphics rendering program to generate a 3-dimensional (3D) image on a display unit) may be decomposed into a plurality of tasks which are executed by multiple slices or multiple processing engines.

In one example, the associated memory units of the information processing system may form a memory hierarchy with a local memory unit or an internal cache memory unit dedicated to each slice, a global memory unit shared among all slices and other memory units with various degrees of shared access. For example, a first level cache memory or L1 cache memory may be a memory unit dedicated to a single processing engine and may be optimized with a faster memory access time at the expense of storage space. For example, a second level cache memory or L2 cache memory may be a memory unit which is shared among more than one processing engine and may be optimized to provide a larger storage space at the expense of memory access time. In one example, each slice or each processing engine includes a dedicated internal cache memory.

In one example, the memory hierarchy may be organized as a cascade of cache memory units with the first level cache memory, the second level cache memory and other memory units with increasing storage space and slower memory access time going up the memory hierarchy. In one example, other cache memory units in the memory hierarchy may be introduced which are intermediate between existing memory units. For example, an L1.5 cache memory, which is intermediate between the L1 cache memory and the L2 cache memory, may be introduced in the memory hierarchy of the information processing system.

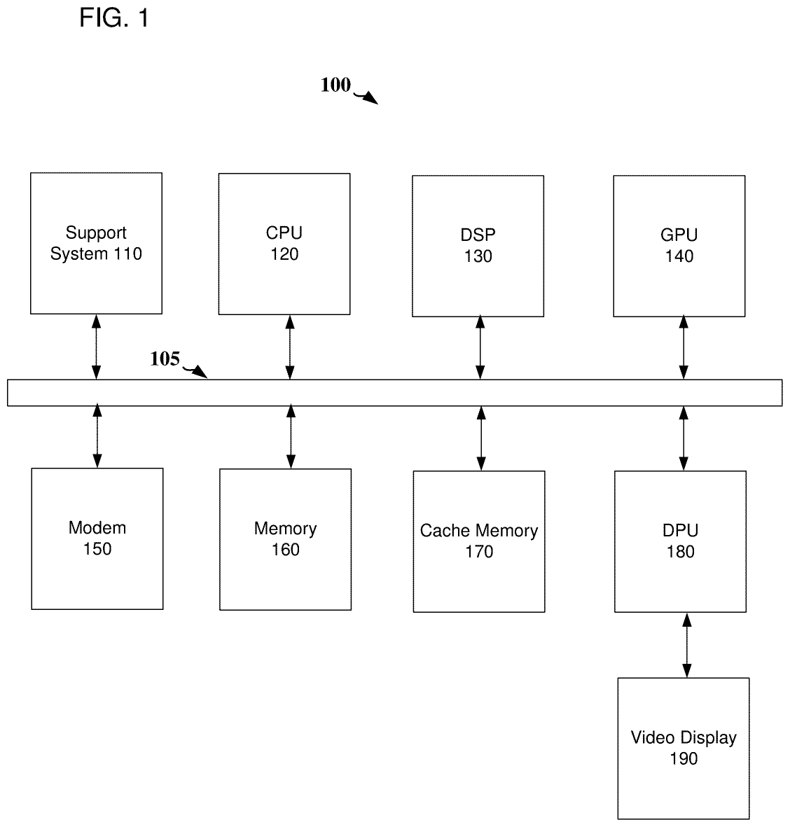

FIG. 1 illustrates an example information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by a databus 105 to transport data and control information. For example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory which is not shared with the other processing engines.

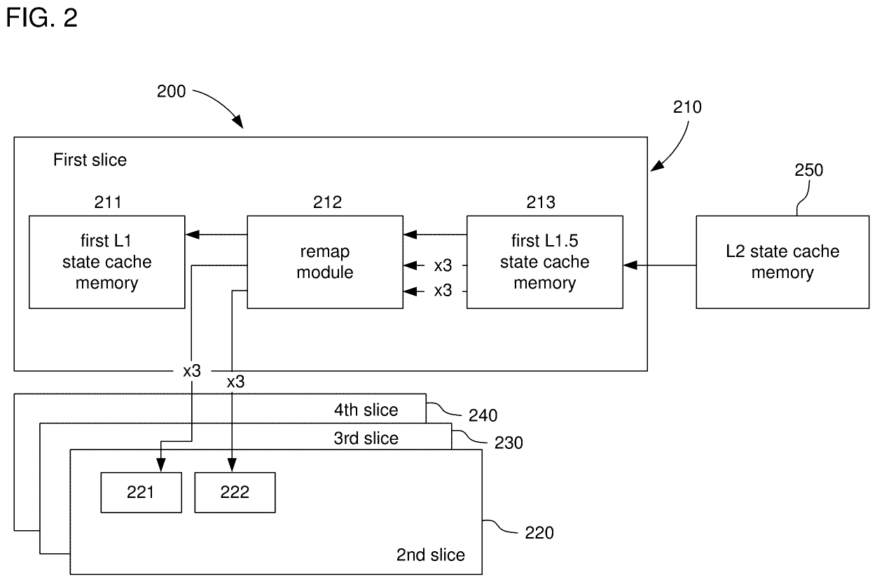

FIG. 2 illustrates an example information processing system 200 with multiple slices. In one example, the information processing system 200 includes a first slice 210, a second slice 220, a third slice 230, a fourth slice 240 and an L2 state cache memory 250. The first slice 210 may include a first L1 state cache memory 211, a remap module 212, a first L1.5 state cache memory 213. In one example, the first L1.5 state cache memory 213 is connected to the L2 state cache memory 250 which is accessible outside the first slice 210. In one example, the remap module 212 receives a state input from the first L1.5 state cache memory 213. In one example, the remap module 212 provides a state output to the first L1 state cache memory 211 and the second slice 220.

In one example, FIG. 2 also illustrates the second slice 220 with a first processor L1 state cache memory 221 and a second processor L1 state cache memory 222. For example, the first processor L1 state cache memory 221 and the second processor L1 state cache memory 222 receive state outputs from the remap module 212. Although four slices are illustrated in the examples here, one skilled in the art would understand that the quantity of slices may be fewer or may be greater than 4 and be within the spirit and scope of the present disclosure. Thus, the example of 4 slices is not limiting and other quantity of slices may be used or implemented.

In one example, the state input is a descriptor tag. In one example, the state output is an updated descriptor tag. In one example, the updated descriptor tag is a remapped descriptor based on updated information.

In one example, a graphics application software module may execute operations on a surface. For example, the surface is an object in a graphical product which may be rendered (i.e., digitally generated). In one example, rendering is a graphical operation to generate a digital image. In one example, for graphics application software module, a software driver may check resource usage in a granularity of draw commands if the surface needs to be remapped to graphics memory. For example, the software driver may program new context register information (e.g., a remapping table) which provides a system memory address and its graphics memory for a remapped surface.

In one example, a descriptor is information which specifies or describes a resource in the information processing system. In one example, the resource may be a shader resource such as a buffer memory, an image view, a sampler, etc. A descriptor may include information regarding the format of the surface, its starting location in memory, the size of the surface and, for a two-dimensional surface, its width and height.

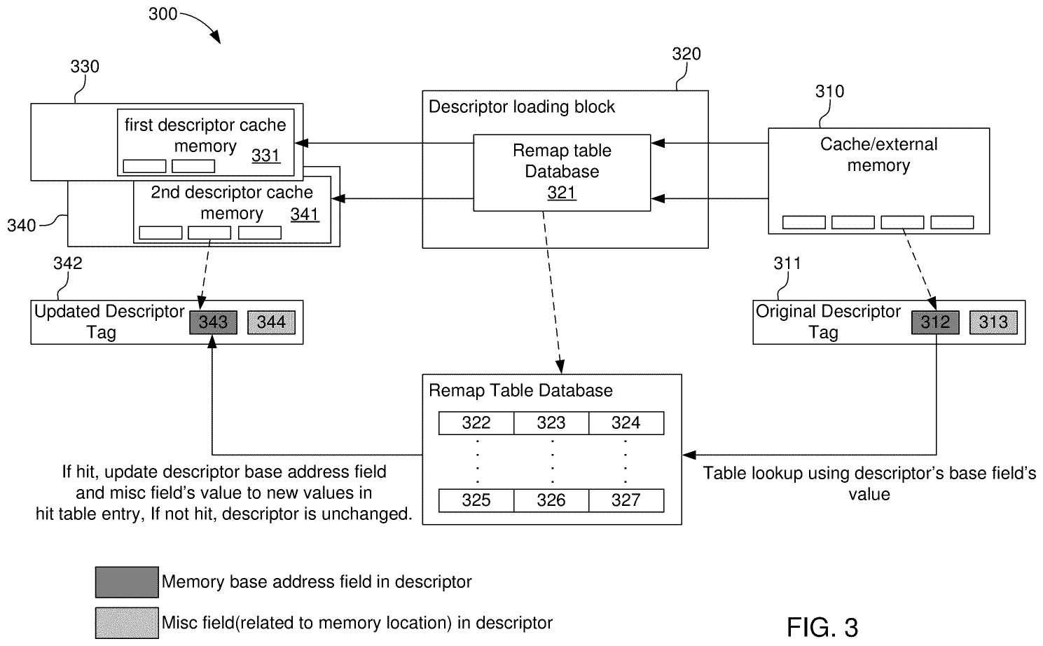

FIG. 3 illustrates an example information processing system 300 for metadata updating. In one example, metadata is information which describes other information. For example, metadata may include a descriptor. In one example, the information processing system 300 includes an external memory 310 (e.g., external cache memory) accessible to a plurality of slices. In one example, contents stored in the external memory 310 include an original descriptor tag 311. For example, the original descriptor tag 311 is a data structure for a resource in the information processing system 300. In one example, the resource may be a shader resource such as a buffer memory, an image view, a sampler, etc. In one example, the original descriptor tag 311 may include an original base value 312 and an original miscellaneous base value 313. In one example, a base value is a starting location in memory. In one example, the original base value 312 is an original starting location in memory. In one example, the original miscellaneous base value 313 is an alternative starting location in memory for surfaces which may have a plurality of starting locations in memory. For example, the original miscellaneous base value 313 may be information in a miscellaneous field related to a surface location in memory.

In FIG. 3, a descriptor loading block 320 receives the original descriptor tag 311 from the external memory 310. In one example, the descriptor loading block 320 is part of a processing engine (not shown). For example, the processing engine includes a processing unit and an internal memory unit. For example, the processing engine includes an internal databus for internal data transfers and an external databus for external data transfers. In one example, the descriptor loading block 320 receives the original descriptor tag 311 using the external databus. In one example, the descriptor loading block 320 may be part of an information processing system (e.g., item 100 illustrated in FIG. 1) and it may include a plurality of processing engines such as a central processing unit (CPU) (e.g., item 120 illustrated in FIG. 1)

In one example, the descriptor loading block 320 includes a remap table database 321. For example, the remap table database 321 may include a plurality of descriptor update tags for updating of metadata. In one example, the metadata includes descriptor tag information such as original base values, updated base values and updated miscellaneous base values. In one example, the remap table database 321 includes a first original base value 322, a first updated base value 323 and a first updated miscellaneous base value 324. In one example, the remap table database 321 includes a plurality of other original base values, a plurality of other updated base values and a plurality of other updated miscellaneous base values up to and including an Nth original base value 325, an Nth updated base value 326 and an Nth updated miscellaneous base value 327.

In one example, the descriptor loading block 320 examines the original base value 312 from the original descriptor tag 311 and compares the original base value 312 to the first original base value 322 in the remap table database 321. In one example, the descriptor loading block 320 compares the original base value 312 to the plurality of other original base values up to and including the Nth original base value 325.

In one example, if there is a match between the original base value 312 and either the first original base value 322 or the plurality of other original base values, then an updated descriptor tag 342 is produced with an updated base value and an updated miscellaneous base value. That is, if there is a match between the original descriptor tag 311 and one description update tag, then an updated descriptor tag 342 is produced.

In one example, if there is a match between the original base value 312 and the first original base value 322, then the updated descriptor tag 342 is produced with new base value 343 and a new miscellaneous base value 344. In one example, the new base value 343 is set to the first updated base value 323. In one example, the new miscellaneous base value 344 is set to the first updated miscellaneous base value 324.

In one example, if there is a match between the original base value 312 and the Nth original base value 325, then the updated descriptor tag 342 is produced with new base value 343 and a new miscellaneous base value 344. In one example, the new base value 343 is set to the Nth updated base value 326. In one example, the new miscellaneous base value 344 is set to the Nth updated miscellaneous base value 327.

In one example, if there is a match between the original base value 312 and either the first original base value 322 or the plurality of other original base values, then the updated descriptor tag 342 with the updated base value and the updated miscellaneous base value is sent to a first auxiliary processing engine 330 and/or a second auxiliary processing engine 340. In one example, the first auxiliary processing engine 330 includes a first descriptor cache memory 331. In one example, the second auxiliary processing engine 340 includes a second descriptor cache memory 341. In one example, the updated descriptor tag 342 is stored in the first descriptor cache memory 331 and the second descriptor cache memory 341.

In one example, the updated base value is the first updated base value 323 and the updated miscellaneous base value is the first miscellaneous base value 324. In one example, the updated base value is the Nth updated base value 326 and the updated miscellaneous base value is the Nth miscellaneous base value 327.

In one example, if there is no match between the original base value 312 and either the first original base value 322 or the plurality of other original base values, then the updated descriptor tag 342 is a replica of the original descriptor tag 311 (i.e., the original descriptor tag 311 is not updated). In one example, the replica of the original descriptor tag 311 is a reproduced original descriptor tag.

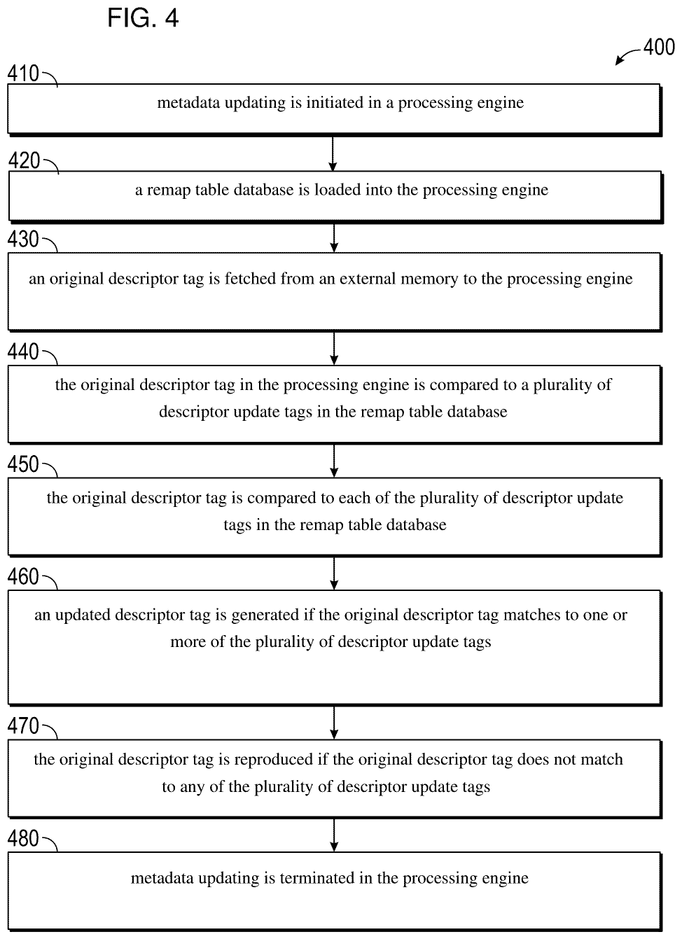

FIG. 4 illustrates a first example flow diagram 400 for updating metadata in an information processing system. In one example, metadata is information which describes other data. For example, metadata may include a descriptor.

In block 410, metadata updating is initiated in a processing engine. In one example, the metadata updating is descriptor updating. For example, a descriptor is information which specifies or describes a resource in the information processing system. In one example, the resource may be a shader resource such as a buffer memory, an image view, a sampler, etc. In one example, initiating metadata updating is performed by the processing engine, for example, a CPU or a GPU.

In block 420, a remap table database is loaded into the processing engine. In one example, the processing engine is a descriptor loading block. In one example, the descriptor loading block is part of the processing engine. In one example, loading the remap table database is performed using a software driver. In one example, the remap table database is loaded into a local memory in the processing engine. In one example, the local memory is an internal memory for the processing engine.

In one example, the remap table database includes a plurality of descriptor update tags. In one example, the plurality of descriptor update tags is used for metadata updating. In one example, the metadata includes descriptor tag information such as original base values, updated base values and updated miscellaneous base values. In one example, the remap table database includes a first original base value, a first updated base value and a first updated miscellaneous base value. In one example, the remap table database includes a plurality of other original base values, a plurality of other updated base values and a plurality of other updated miscellaneous base values up to and including an Nth original base value, an Nth updated base value and an Nth updated miscellaneous base value.

In block 430, an original descriptor tag is fetched from an external memory to the processing engine. In one example, the original descriptor tag is a data structure for a resource in the information processing system. In one example, the resource may be a shader resource such as a buffer memory, an image view, a sampler, etc. In one example, the original descriptor tag may include an original base value and an original miscellaneous base value. In one example, the external memory is a shared memory for a plurality of processing engines.

In block 440, the original descriptor tag in the processing engine is compared to a plurality of descriptor update tags in the remap table database. In one example, a descriptor update tag includes an original base value, an updated base value and an updated miscellaneous base value. In one example, the comparison is performed in the processing engine.

In block 450, the original descriptor tag is compared to each of the plurality of descriptor update tags in the remap table database.

In block 460, an updated descriptor tag is generated if the original descriptor tag matches to one or more of the plurality of descriptor update tags. In one example, the generation of the updated descriptor tag is performed in the processing engine. In one example, the updated descriptor tag includes an updated base value and an updated miscellaneous base value. In one example, the updated descriptor tag with the updated base value and the updated miscellaneous base value is sent to a first auxiliary processing engine and a second auxiliary processing engine. In one example, the first auxiliary processing engine includes a first descriptor cache memory. In one example, the second auxiliary processing engine includes a second descriptor cache memory. In one example, the updated descriptor tag is stored in the first descriptor cache memory and the second descriptor cache memory.

In block 470, the original descriptor tag is reproduced if the original descriptor tag does not match to any of the plurality of descriptor update tags. In one example, reproducing the original descriptor tag is making a copy of the original descriptor tag and relabeling the copy as an updated descriptor tag. In one example, the reproduction of the original descriptor tag is performed in the processing engine. In one example, the reproduced original descriptor tag includes a reproduced original base value and a reproduced original miscellaneous base value.

In block 480, metadata updating is terminated in the processing engine. In one example, the metadata updating is descriptor updating.

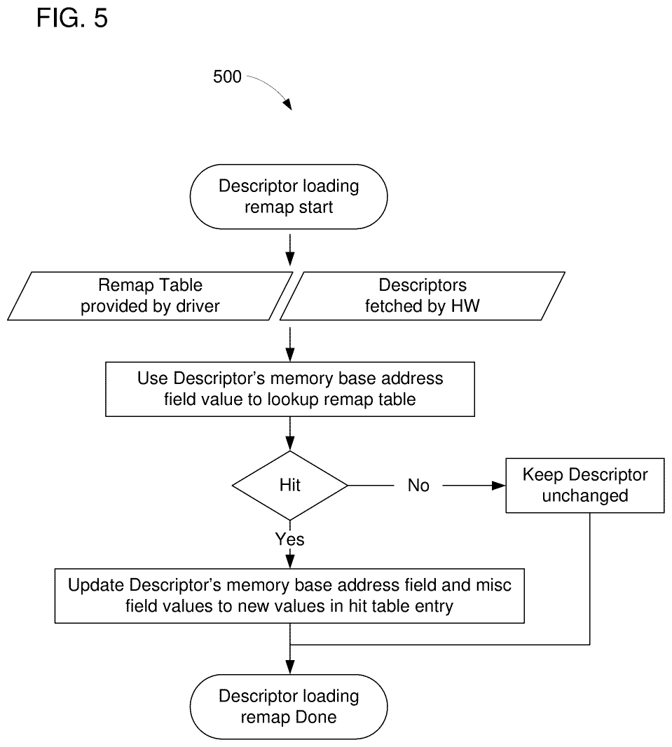

FIG. 5 illustrates an example flow diagram 500 for updating a descriptor in an information processing system. In one example, FIG. 5 is a specific implementation for updating metadata in an information processing system, wherein the metadata is a descriptor. One skilled in the art would understand that although the example flow diagram 400 of FIG. 4 is disclosed for updating metadata, that its steps may also be implemented to update a specific metadata type, i.e., a descriptor, in an information processing system.

In one aspect, one or more of the steps in FIGS. 4 and 5 may be executed by one or more processors which may include hardware, software, firmware, etc. In one aspect, one or more of the steps in FIGS. 4 and 5 may be executed by one or more processors which may include hardware, software, firmware, etc. The one or more processors, for example, may be used to execute software or firmware needed to perform the steps in the flow diagrams of FIGS. 4 and 5. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
a non-transitory external memory unit configured for storing an original descriptor tag, wherein the original descriptor tag includes information of an object which is rendered and a value related to a graphical surface location;
a remap table database coupled to the non-transitory external memory unit, the remap table database to store a plurality of original base values, a plurality of updated base values, and a plurality of updated miscellaneous base values, wherein each of the plurality of original base values represents a starting surface location in the non-transitory external memory unit; and
a descriptor loading block coupled to the non-transitory external memory, the descriptor loading block to fetch the original descriptor tag from the non-transitory external memory for storage in an internal cache memory and to compare an original base value of the original descriptor tag stored in the internal cache memory to each of the plurality of original base values in the remap table database, and to replace the original base value of the original descriptor tag with an updated base value of the plurality of updated base values in the remap table database, wherein the original base value is not equal to the updated base value.

2. The apparatus of claim 1, wherein the object is in a graphical product.

3. The apparatus of claim 1, wherein the descriptor loading block is further to replace an original miscellaneous base value of the original descriptor tag with an updated miscellaneous base value of the plurality of updated miscellaneous base values.

4. The apparatus of claim 3, wherein the descriptor loading block is to store an updated descriptor tag in the internal cache memory unit within the descriptor loading block.

5. The apparatus of claim 4, wherein the updated descriptor tag includes the updated base value and the updated miscellaneous base value.

6. The apparatus of claim 5, further comprising a first auxiliary processing engine to utilize the updated descriptor tag.

7. The apparatus of claim 6, further comprising a second auxiliary processing engine to utilize the updated descriptor tag.

8. The apparatus of claim 1, wherein the remap table database is part of the descriptor loading block.

9. The apparatus of claim 8, wherein the internal cache memory is dedicated to the descriptor loading block.

10. A method for updating metadata, the method comprising:
fetching an original descriptor tag from a non-transitory external memory, wherein the non-transitory external memory stores a plurality of original base values, a plurality of updated base values, a plurality of miscellaneous base values, and a plurality of updated miscellaneous base values, and wherein each of the plurality of original base values represents a starting surface location in the non-transitory external memory unit;
storing the original descriptor tag in an internal cache memory of a processing engine, and wherein the original descriptor tag includes information of an object which is rendered and a value related to a graphical surface location;
comparing the original descriptor tag to a plurality of descriptor update tags, wherein the original descriptor tag and the plurality of descriptor update tags are stored in the internal cache memory; and
replacing an original base value of the original descriptor tag with an updated base value of the plurality of updated base values, wherein the original base value is not equal to the updated base value.

11. The method of claim 10, wherein the object is in a graphical product.

12. The method of claim 10, further comprising generating an updated descriptor tag if the original descriptor tag matches one or more of the plurality of descriptor update tags.

13. The method of claim 12, further comprising replacing an original miscellaneous base value of the original descriptor tag with an updated miscellaneous base value of the plurality of updated miscellaneous base values.

14. The method of claim 12, wherein the plurality of updated base values and the plurality of updated miscellaneous base values are stored in a remap table database within the processing engine.

15. The method of claim 10, wherein the plurality of descriptor update tags is stored in a remap table database within the processing engine.

16. The method of claim 10, wherein the internal cache memory is dedicated to the processing engine.

17. An apparatus for updating metadata, the apparatus comprising:
means for storing a plurality of original base values, a plurality of updated base values, a plurality of miscellaneous base values, and a plurality of updated miscellaneous base values, and wherein each of the plurality of original base values represents a starting surface location in the non-transitory external memory unit;
means for fetching an original descriptor tag from the non-transitory external memory;
means for storing the original descriptor tag within a processing engine;
means for comparing the original descriptor tag to a plurality of descriptor update tags, wherein the original descriptor tag and the plurality of descriptor update tags are stored in an internal cache memory; and
means for replacing an original base value of the original descriptor tag with an updated base value of the plurality of updated base values, wherein the original base value is not equal to the updated base value, and wherein the original descriptor tag includes information of an object which is rendered and a value related to a graphical surface location.

18. The apparatus of claim 17, further comprising means for generating an updated descriptor tag if the original descriptor tag matches one or more of the plurality of descriptor update tags.

19. The apparatus of claim 17, wherein the object is in a graphical product.

20. The apparatus of claim 18, further comprising means for replacing an original miscellaneous base value of the original descriptor tag with an updated miscellaneous base value of the plurality of updated miscellaneous base values.
